(19) United States
(12) Patent Application Publication
(10) Pub. No.: US 2024/0286785 A1
(43) Pub. Date: Aug. 29, 2024

(54) EQUIPMENT FOR APPLYING LABELS ON CORRESPONDING CONTAINERS, IN PARTICULAR IN THE FORM OF BOTTLES

(71) Applicant: NEWTEC LABELLING S.R.L., Goito (MN) (IT)

(72) Inventor: Massimo PIPPA, Goito (MN) (IT)

(21) Appl. No.: 18/575,148

(22) PCT Filed: Jun. 23, 2022
(86) PCT No.: PCT/IB2022/055831

§ 371 Date: Dec. 28, 2023

(30) Foreign Application Priority Data
Jul. 2, 2021 (IT) 102021000017486

(51) Int. Cl. B65C 9/18; B65C 3/08; B65C 9/04

(52) U.S. Cl. CPC B65C 9/1819; B65C 3/08; B65C 9/04

(57) ABSTRACT

Equipment (10) for applying labels (11) on corresponding containers (13), in particular in the form of bottles, especially in the form of containers, or bottles, (13) made of plastic material; said equipment (10) comprising movable means (12) for transferring the respective label (11) onto the respective container, or bottle, (13), in particular in the form of a corresponding rotatable body (12) having an outer peripheral surface (121) for engaging and releasing a corresponding label (11) onto a corresponding container, or bottle, (13), said movable means, or rotatable body, (12) for transferring the respective label (11) onto the respective container, or bottle, (13) including means (16) for introducing said suction, and possibly blowing, flow into said movable means, or rotatable body, (12) for transferring the respective label (11) onto the respective container, or bottle. Said means (16) for introducing said suction, and possibly blowing, flow, into said movable means, or rotatable body, (12) for transferring the respective label (11) onto the respective container, or bottle, (13), are in the form of, or consist of, a corresponding body made of metal material, in particular steel.

### FIELD OF APPLICATION OF THIS INVENTION

The present invention relates to an equipment for applying labels on corresponding containers, in particular in the form of bottles, especially in the form of containers, or bottles, in plastic material.

### STATE OF THE ART

Equipment for applying labels on corresponding bottles made of plastic material is known, which comprise movable means for transferring the respective label onto the bottle, which are in the form of a corresponding rotatable body that has an outer peripheral surface for engaging and releasing a corresponding label on a corresponding container, or bottle, and wherein said movable means, or rotatable body, for transferring the respective label onto the respective container, or bottle, comprise means, for sucking, and possibly blowing, the respective label onto, or from, said outer peripheral surface for engaging and releasing corresponding labels, through a corresponding suction, and possibly blowing flow.

In the already known equipment, for applying labels on corresponding bottles, said movable means, or rotatable body, for transferring the respective label onto the respective container, or bottle, comprise respective means for introducing said suction flow into said movable means, or rotatable body, for transferring the respective label onto the respective container, or bottle, which introduction means are in the form of a corresponding body made of plastic material that slides on corresponding fixed means for supplying a corresponding suction, and possibly blowing, flow, with which they interface.

In this way, however, it is not possible to obtain the passage of said suction, and possibly blowing, flow, without requiring the use of contact bodies made of plastic material that deform and must be, in order to maintain functionality, periodically ground, with consequent machine downtimes and the need to perform burdensome and expensive disassembly grinding and reassembly processings.

### SUMMARY OF THE INVENTION

With the present invention it is therefore wished to propose a new solution and/or an alternative to the solutions known up to now and in particular it is proposed to overcome one or more of the drawbacks or problems referred to above, and/or to satisfy one or more requirements referred to above and/or in any case experienced in the art, and in particular which can be deduced from the above.

An equipment is thus provided for applying labels on corresponding containers, in particular in the form of bottles, especially in the form of containers, or bottles, made of plastic material; said equipment comprising movable means for transferring the respective label onto the respective container, or bottle, in particular in the form of a corresponding rotatable body having an outer peripheral surface for engaging and releasing a corresponding label onto a corresponding container, or bottle; said movable means, or rotatable body, for transferring the respective label onto the respective container, or bottle, including means, for sucking, and possibly blowing, the respective label onto, or from, said peripherally outer surface for engaging and releasing corresponding labels, through a corresponding suction, and possibly blowing flow; said movable means, or rotatable body, for transferring the respective label onto the respective container, or bottle, comprising means for introducing said suction, and possibly blowing, flow into said movable means, or rotatable body, for transferring the respective label onto the respective container, or bottle; which introduction means are adapted to interface with corresponding fixed means for supplying a corresponding suction, and possibly blowing, flow to said movable means, or rotatable body, for transferring the respective label onto the respective container, or bottle; characterized in that said means for introducing said suction, and possibly blowing, flow into said movable means, or rotatable body, for transferring the respective label onto the respective container, or bottle, are in the form of, or consist of, a corresponding body made of metal material, in particular steel.

In this way, it is possible to obtain the passage of said suction, and possibly blowing, flow, without requiring the use of contact bodies made of plastic material that deform and must be suitably ground, with consequent machine downtimes and the need to perform burdensome and expensive processings.

### BRIEF DESCRIPTION OF THE DRAWINGS

This and other innovative aspects or respective advantageous embodiments, are however, set forth in the appended claims, the technical characteristics of which can be found, together with corresponding advantages achieved, in the following detailed description, illustrating a purely non-limiting example of the embodiment of the invention, which is made with reference to the appended drawings, in which:

FIG. 1 illustrates a schematic plan view from above of a preferred embodiment of equipment according to the present invention;

FIG. 2 illustrates a schematic view in exploded perspective, partially sectioned, of the preferred embodiment of said movable means, or rotatable body, for transferring the respective label onto the respective container, or bottle, used in the equipment according to the present invention;

FIG. 3 illustrates a schematic view in longitudinal section of a preferred embodiment of said movable means, or rotatable body, for transferring the respective label onto the respective container, or bottle, used in the equipment according to the present invention;

FIG. 4 illustrates a schematic view in exploded longitudinal section of a preferred embodiment of said movable means, or rotatable body, for transferring the respective label onto the respective container, or bottle, used in the equipment according to the present invention;

FIG. 5 illustrates a schematic plan view from above of a preferred embodiment of said fixed means for the passage of a corresponding suction, and possibly blowing, flow, to said movable means for transferring the respective label onto the respective container, or bottle, which are used in the preferred embodiment of equipment according to the present invention;

FIG. 6 illustrates a schematic plan view from below of the preferred embodiment of movable means, or rotatable body, for transferring the respective label onto the respective container, or bottle, used in the preferred embodiment of equipment according to the present invention;

FIG. 7 illustrates a schematic view in horizontal section of the preferred embodiment of movable means, or rotatable body, for transferring the respective label onto the respective container, or bottle, used in the preferred embodiment of equipment according to the present invention.

### DETAILED DESCRIPTION OF PREFERRED EMBODIMENTS OF THE INVENTION

The attached figures illustrate a preferred embodiment 10 of equipment for applying labels 11, on corresponding containers 13, in particular in the form of bottles, especially in the form of containers, or bottles, 13 made of plastic material. In particular, said label 11 being adapted to circumferentially wrap the body of said container, or bottle, 13, with overlap and reciprocal gluing of the longitudinal ends thereof.

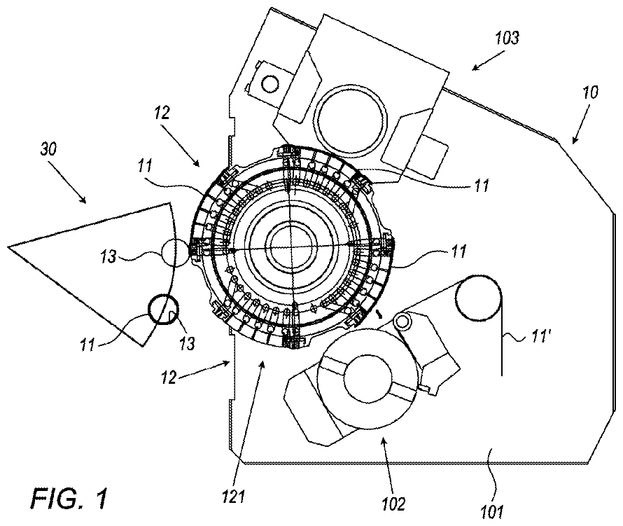

Said equipment 10 comprises, as can be seen from FIG. 1, support means, or framing, 101 for means 102 for cutting a respective label 11 from a corresponding label strip 11′, in particular as will be better seen from the following description, which are adapted to yield the respective label 11 on a circumferential surface for engaging and releasing a corresponding label 11 of corresponding means 12 for transferring said label 11 onto the respective container, or bottle, 13, especially rotatably supported by said support means, or framing, 12 of the same equipment 10, and cooperating with means 30 for advancing the respective container, or bottle, 13, in particular in the form of a corresponding rotatable carrousel, to achieve the application of the label on the respective container, or bottle 11.

The framing 101 also supports means 103 for applying a corresponding adhesive or glue on the respective label 11, in particular with said label 11 which is supported on said means 12 for transferring, in particular for applying said adhesive or glue on corresponding longitudinal ends of the same label 11.

Said equipment 10 therefore comprises, as previously reported, movable means for transferring the respective label 11 onto the respective container, or bottle, 13, in particular in the form of a corresponding rotatable body 12 having, as reported, an outer peripheral surface 121 for engaging and releasing a corresponding label 11 onto a corresponding container, or bottle, 13.

Said movable means, or rotatable body, 12 for transferring the respective label 11 onto the respective container, or bottle, 13 include means 14 for sucking, and possibly blowing, the respective label 11 onto, or from, said peripherally outer surface 121 for engaging and releasing corresponding labels 11, through a corresponding suction, and possibly blowing flow.

Said movable means, or revolving body, 12 for transferring the respective label 11 onto the respective container, or bottle, 13, comprise means 16 for introducing said suction, and possibly blowing, flow into said movable means, or rotatable body, 12 for transferring the respective label 11 onto the respective container, or bottle, 13; which introduction means 16 are adapted to interface with corresponding fixed means 18 for supplying a corresponding suction, and possibly blowing, flow to said movable means, or rotatable body, 12 for transferring the respective label 11 onto the respective container, or bottle, 13.

Advantageously, said means 16 for introducing said suction, and possibly blowing, flow, into said movable means, or rotatable body, 12 for transferring the respective label 11 onto the respective container, or bottle, 13, are in the form of, or consist of, a corresponding body made of metal material, in particular steel.

In this way, it is possible to obtain the passage of said suction, and possibly blowing, flow, without requiring the use of contact bodies made of plastic material that deform and must be maintained, or suitably ground, with consequent machine downtimes and the need to perform burdensome and expensive processings.

As can be seen from said FIGS. 1 to 7, in an appreciably advantageous way, said means 16 for introducing said suction, and possibly blowing, flow into said movable means, or rotatable body, 12 for transferring the respective label 11 onto the respective container, or bottle, 13 have a corresponding outer face, in particular a lower outer face, 161, provided with corresponding opening means 162 for receiving said suction, and possibly blowing, flow, said outer face 161 being adapted to interface with a corresponding outer face, in particular an upper outer face, 181, of said fixed means 18 for the passage of a corresponding suction, and possibly blowing, flow, in which outer face 181 there are provided corresponding opening means 182 for yielding said suction, and possibly blowing, flow to said opening means 162 of said means 16 for introducing said suction, and possibly blowing, flow.

As can be seen from said FIGS. 1 to 7, advantageously, said means 16 for introducing said suction, and possibly blowing, flow, into said movable means, or rotatable body, 12 for transferring the respective label 11 onto the respective container, or bottle, 13, or said outer interface face 161 thereof, is in a close position and without contact with said fixed means 18 for the passage of a corresponding suction, and possibly blowing, flow to said movable means 12 for transferring the respective label 11 onto the respective container, or bottle, 13, i.e. with said external interface face 181 thereof.

With particular advantage, as can be seen from said FIGS. 1 to 7, said means 16 for introducing said suction, and possibly blowing, flow into said movable means, or rotatable body, 12 for transferring the respective label 11 onto the respective container, or bottle, 13, i.e. said outer interface face 161 thereof, moves lying in a corresponding plane parallel to said fixed means 18 for the passage of a corresponding suction, and possibly blowing, flow to said movable means 12 for transferring the respective label 11 onto the respective container, or bottle, 13, or parallel to said outer interface face 181 thereof.

As can be seen from said FIGS. 1 to 7, appreciably advantageously, a corresponding lubricating substance, i.e. in the form of a corresponding fatty matter, in particular in the form of corresponding thin circumferential strips of this substance or matter, which are provided at respective zones, in particular radial, which is internal and external of said surfaces 161, 181, is interposed, or are interposed, between said means 16 for introducing said suction, and possibly blowing, flow into said movable means, or rotatable body, 12 for transferring the respective label 11 onto the respective container, or bottle, 13, or between said outer interface face 161 thereof, and said fixed means 18 for the passage of a corresponding suction, and possibly blowing, flow to said movable means 12 for transferring the respective label 11 onto the respective container, or bottle, 13, or said outer interface face 181 thereof, so as to make airtight the passage of said suction, and possibly blowing, flow between the same movable means, or rotatable body, 12 for transferring the respective label 11 onto the respective container, or bottle, 13, and the fixed means 18 for the passage of a corresponding suction, and possibly blowing, flow.

As can be seen from said FIGS. 1 to 7, advantageously, said means 16 for introducing said suction, and possibly blowing, flow, into said movable means, or rotatable body, 12 for transferring the respective label 11 onto the respective container, or bottle, 13, or said outer interface face 161 thereof, are spaced apart, or is spaced apart from said fixed means 18 for the passage of a corresponding suction, and possibly blowing, flow to said movable means 12 for transferring the respective label 11 onto the respective container, or bottle, 13, or from said outer interface face 181 thereof, in an amount equal to, or about, 0.1 mm.

Advantageously, as can be seen from said FIGS. 1 to 7, said means 16 for introducing said suction, and possibly blowing, flow into said movable means, or rotatable body, 12 for transferring the respective label 11 onto the respective container, or bottle, 13, are in the form of a corresponding element 160, in particular being in general discoidal in shape, preferably conformed as a circular crown in shape.

As can be seen from said FIGS. 1 to 7, with advantage, said means 16 for introducing said suction, and possibly blowing, flow into said movable means, or rotatable body, 12 for transferring the respective label 11 onto the respective container, or bottle, 13, are in the form of a flat plate 160, in particular having a lower flat interface face 161, and preferably including an upper flat face 163, parallel to said lower flat face 161, as well as especially comprising an outer circular edge 164 and an inner circular edge 165 that are concentric with each other. As illustrated, said opening means 162 for introducing said suction, and possibly blowing, flow into said movable means, or rotatable body, 12 for transferring the respective label 11 onto the respective container, or bottle, 13, are extended perpendicularly passing through said flat plate 160.

As can be seen from said figures, with particular advantage, said flat plate 160 of said movable means, or rotatable body, 12 for transferring the respective label 11 onto the respective container, or bottle, 13, is configured rigid, or substantially rigid, in particular with reference to the deflection perpendicularly to the plane of said same flat plate 160, i.e. preferably it has a thickness between 6 mm and 20 mm, and which is preferably about 10 mm.

As can be seen from said FIGS. 1 to 7, in a particularly advantageous way, said movable means, or rotatable body, 12 for transferring the respective label 11 onto the respective container, or bottle, 13, comprise a main supporting body 120, in particular with cross section conformed in general as cup-shaped, facing downwards, defining said peripherally outer surface 121 for engaging the respective label 11, on which corresponding suction, and possibly blowing, holes 122 open, and defining a circumferential chamber 123 for the peripheral distribution of said suction, and possibly blowing, flow in communication with said holes 122 and with said opening means 162 for introducing said suction, and possibly blowing, flow into said movable means, or rotatable body, 12 for transferring the respective label 11 onto the respective container, or bottle, 13.

Said circumferential chamber for the peripheral distribution 123 has a horizontal section parallel and rear, or internal, to said flat plate 160 defining said means 16 for introducing said suction, and possibly blowing, flow, from which flat section a corresponding section is extended perpendicular parallel and rear, or internal, to said peripherally outer surface for engaging and retaining 121 the same movable means, or rotatable body, 12 for transferring the respective label 11 onto the respective container, or bottle, 13.

As can be seen from the said figures, with advantage, said main supporting body 120 of said movable means, or rotatable body, 12 for transferring the respective label 11 onto the respective container, or bottle, 13, has a protruding edge 129, in particular at the bottom, for engaging a corresponding edge, in particular an outer edge, 164 of said flat plate 160 defining said means 16 for introducing said suction, and possibly blowing, flow, into said movable means, or rotatable body, 12 for transferring the respective label 11 onto the respective container, or bottle, 13. Said protruding edge 129 defines means for positioning the same flat plate 160 on said movable means, or rotatable body, 12 for transferring the respective label 11 onto the respective container, or bottle, 13.

As can be seen from said FIGS. 1 to 7, in a particularly advantageous way, said means 16 for introducing said suction, and possibly blowing, flow into said movable means, or rotatable body, 12 for transferring the respective label 11 onto the respective container, or bottle, 13, are integral with said main body 120 of said movable means, or rotatable body, 12 for transferring the respective label 11 onto the respective container, or bottle, 13, in particular by means of corresponding fixing screws, preferably inserted perpendicularly, in particular from the bottom upwards.

As can be seen from said FIGS. 1 to 7, appreciably advantageously, said movable means, or rotatable body, 12 for transferring the respective label 11 onto the respective container, or bottle, 13, comprise, or comprises, a plurality of circumferential zones 126 for engaging and retaining a corresponding label 11, which are delimited by respective radially projecting end areas 127, 128, in particular defined by corresponding radially yielding skid portions.

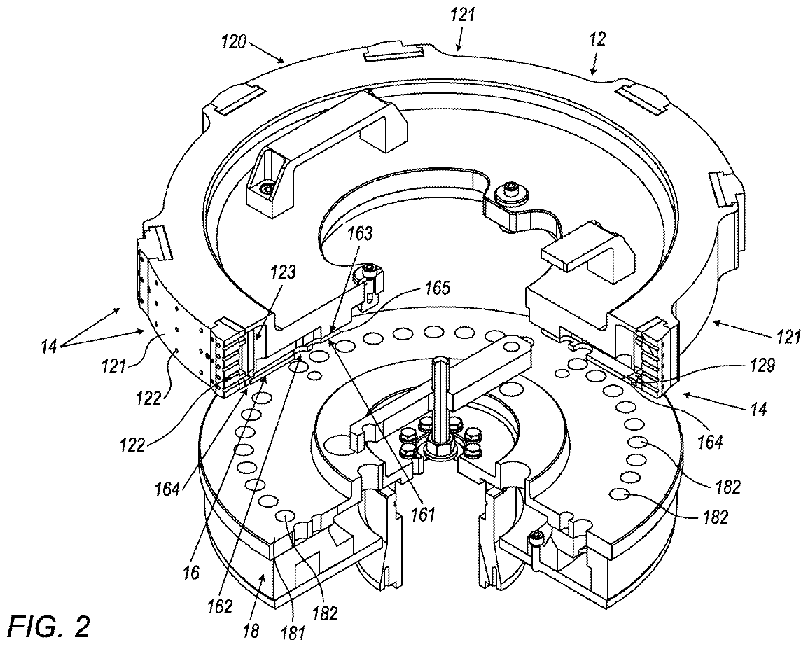

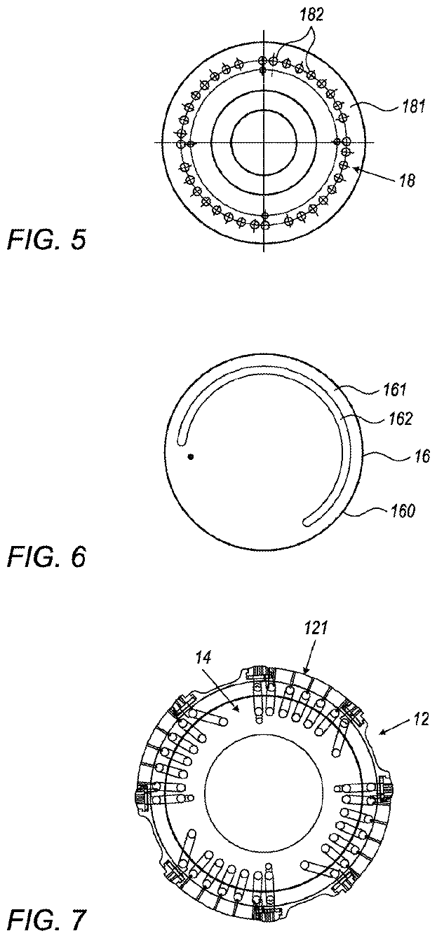

As can be seen in particular from FIGS. 2 and 5, said opening means 182 for yielding said suction, and possibly blowing, flow of said fixed means 18, to said opening means 162 of said introduction means 16, comprise a plurality of circumferentially distributed holes, in particular distributed along substantially the entire outer surface 181 of said fixed means 18 for transferring said suction, and possibly blowing, flow.

In turn, as can be seen in particular from FIG. 6, said opening means 162 for receiving said suction, and possibly blowing, flow, of said means 16 for introducing said suction, and possibly blowing, flow, have a circumferentially extended configuration, preferably being defined by a single circumferentially extended slit 162, in particular having an angular extension greater than 180°, in particular slightly less than 270°.

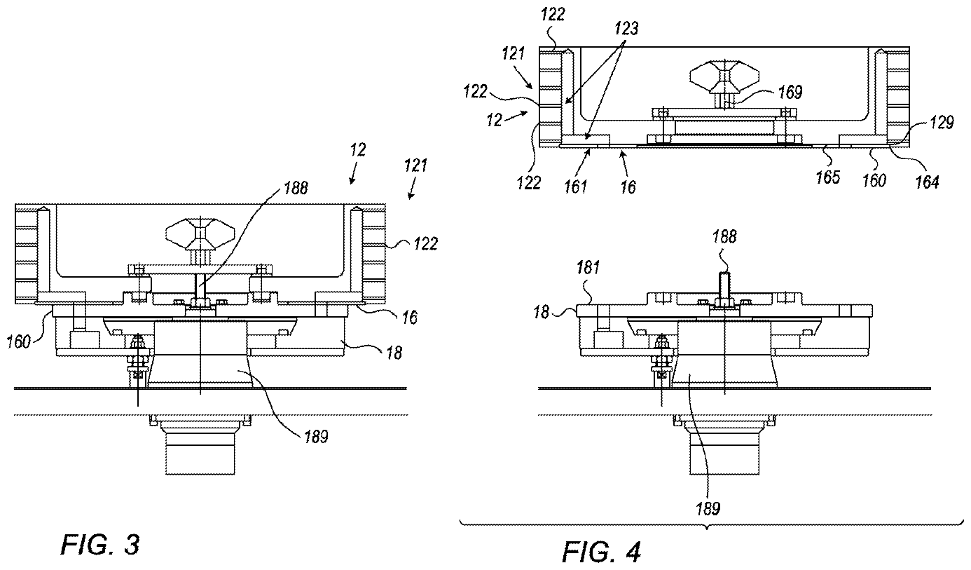

Preferably, as illustrated, a central body 189 supporting said fixed means 18 centrally supports, in a rotatable manner, a corresponding shaft 188 on which, said rotatable means 12 for applying the label are engaged and supported, as can be clearly seen from said FIGS. 3 and 4. As illustrated, said rotatable means for applying the label 12 have a corresponding central seat 169 which is adapted to engage on said shaft 188.

In practice, as is evident, the technical characteristics illustrated above allow, individually or in a respective combination, achieving one or more of the following advantageous results:
it is possible to obtain the passage of said suction, and possibly blowing, flow, without requiring the use of contact bodies made of plastic material that deform and must be maintained, or suitably ground, with consequent machine downtimes and the need to perform burdensome and expensive processings.

The present invention is susceptible to evident industrial application. The person skilled in the art will also be able to imagine numerous modifications and/or variations to be made to the same invention, while remaining within the scope of the inventive concept, as extensively explained. Furthermore, the person skilled in the art will be able to imagine further preferred embodiments of the invention comprising one or more of the above illustrated features of the above-referenced preferred embodiment, in particular as set forth in the appended claims. Moreover, it must also be understood that all the details of the invention can be replaced by technically equivalent elements.

1. Equipment for applying labels on corresponding containers, in particular in the form of bottles, especially in the form of containers, or bottles, made of plastic material; said equipment comprising movable means for transferring the respective label onto the respective container, or bottle, in particular in the form of a corresponding rotatable body having an outer peripheral surface for engaging and releasing a corresponding label onto a corresponding container, or bottle, said movable means, or rotatable body, for transferring the respective label onto the respective container, or bottle, including means for sucking, and possibly blowing, the respective label onto, or from, said peripherally outer surface for engaging and releasing corresponding labels, through a corresponding suction, and possibly blowing flow; said movable means, or rotatable body, for transferring the respective label onto the respective container, or bottle, comprising means for introducing said suction, and possibly blowing, flow into said movable means, or rotatable body, for transferring the respective label onto the respective container, or bottle; which introduction means are adapted to interface with corresponding fixed means for supplying a corresponding suction, and possibly blowing, flow to said movable means, or rotatable body, for transferring the respective label onto the respective container, or bottle, characterized in that said means for introducing said suction, and possibly blowing, flow into said movable means, or rotatable body, for transferring the respective label onto the respective container, or bottle, are in the form of, or consist of, a corresponding body made of metal material, in particular steel.

2. Equipment according to claim 1, wherein said means for introducing said suction, and possibly blowing, flow into said movable means, or rotatable body, for transferring the respective label onto the respective container, or bottle, have a corresponding outer face, in particular a lower outer face, provided with corresponding opening means for receiving said suction, and possibly blowing, flow, said outer face being adapted to interface with a corresponding outer face, in particular an upper outer face, of said fixed means for the passage of a corresponding suction, and possibly blowing, flow, in which outer face there are provided corresponding opening means for yielding said suction, and possibly blowing, flow to said opening means of said means for introducing said suction, and possibly blowing, flow.

3. Equipment according to claim 1, wherein said means for introducing said suction, and possibly blowing, flow into said movable means, or rotatable body, for transferring the respective label onto the respective container, or bottle, i.e. said outer interface face thereof, is in a close position and without contact with said fixed means for the passage of a corresponding suction, and possibly blowing, flow to said movable means for transferring the respective label onto the respective container, or bottle, i.e. with said outer interface face thereof.

4. Equipment according to claim 1, wherein said means for introducing said suction, and possibly blowing, flow into said movable means, or rotatable body, for transferring the respective label onto the respective container, or bottle, i.e. said outer interface face thereof, moves by lying in a corresponding plane parallel to said fixed means for the passage of a corresponding suction, and possibly blowing, flow to said movable means for transferring the respective label onto the respective container, or bottle, or parallel to said outer interface face thereof.

5. Equipment according to claim 1, wherein a corresponding lubricating substance, i.e. in the form of a corresponding fatty matter, in particular in the form of corresponding thin circumferential strips of this substance or matter, is interposed, or are interposed, between said means for introducing said suction, and possibly blowing, flow into said movable means, or rotatable body, for transferring the respective label onto the respective container, or bottle, or between said outer interface face thereof, and said fixed means for the passage of a corresponding suction, and possibly blowing, flow to said movable means for transferring the respective label onto the respective container, or bottle, or said outer interface face thereof, so as to make airtight the passage of said suction, and possibly blowing, flow between the same movable means, or rotatable body, for transferring the respective label onto the respective container, or bottle, and the fixed means for the passage of a corresponding suction, and possibly blowing, flow.

6. Equipment according to claim 1, wherein said means for introducing said suction, and possibly blowing, flow into said movable means, or rotatable body, for transferring the respective label onto the respective container, or bottle, i.e. said outer interface face thereof, are spaced apart from, or is spaced apart from, said fixed means for the passage of a corresponding suction, and possibly blowing, flow to said movable means for transferring the respective label onto the respective container, or bottle, or from said outer interface face thereof, in an amount equal to, or about, 0.1 mm.

7. Equipment according to claim 1, wherein said means for introducing said suction, and possibly blowing, flow into said movable means, or rotatable body, for transferring the respective label onto the respective container, or bottle, are in the form of a corresponding element, in particular being in general discoidal in shape, preferably conformed as a circular crown in shape.

8. Equipment according to claim 1, wherein said means for introducing said suction, and possibly blowing, flow into said movable means, or rotatable body, for transferring the respective label onto the respective container, or bottle, are in the form of a flat plate.

9. Equipment according to claim 8, wherein said flat plate of said movable means, or rotatable body, for transferring the respective label onto the respective container, or bottle, is configured rigid, or substantially rigid, in particular with reference to the deflection perpendicularly to the plane of said same flat plate, i.e. preferably it has a thickness between 6 mm and 20 mm, and which is preferably about 10 mm.

10. Equipment according to claim 1, wherein said movable means, or rotatable body, for transferring the respective label onto the respective container, or bottle, comprise a main supporting body, in particular with cross section conformed in general as cup-shaped, defining said peripherally outer surface for engaging the respective label, on which corresponding suction, and possibly blowing, holes open, and defining a circumferential chamber for the peripheral distribution of said suction, and possibly blowing, flow in communication with said holes and with said opening means for introducing said suction, and possibly blowing, flow into said movable means, or rotatable body, for transferring the respective label onto the respective container, or bottle.

11. Equipment according to claim 10, wherein said main supporting body of said movable means, or rotatable body, for transferring the respective label onto the respective container, or bottle, has a protruding edge, in particular at the bottom, for engaging a corresponding edge, in particular an outer edge, of said flat plate defining said means for introducing said suction, and possibly blowing, flow, into said movable means, or rotatable body, for transferring the respective label onto the respective container, or bottle; said protruding edge defining means for positioning the same flat plate on said movable means, or rotatable body, for transferring the respective label onto the respective container, or bottle.

12. Equipment according to claim 1, wherein said means for introducing said suction, and possibly blowing, flow into said movable means, or rotatable body, for transferring the respective label onto the respective container, or bottle, are integral with said main body of said movable means, or rotatable body, for transferring the respective label onto the respective container, or bottle, in particular by means of corresponding fixing screws, preferably inserted perpendicularly, in particular from the bottom upwards.

13. Equipment according to claim 1, wherein said movable means, or rotatable body, for transferring the respective label onto the respective container, or bottle, comprise, or comprises, a plurality of circumferential zones for engaging and retaining a corresponding label, which are delimited by respective radially projecting end areas, in particular defined by corresponding radially yielding skid portions.

14. Equipment, wherein it is made according to claim 1 and/or as described and illustrated with reference to the accompanying drawings.
